(19) United States
(12) Patent Application Publication
(10) Pub. No.: US 2024/0285467 A1
(43) Pub. Date: Aug. 29, 2024

(54) MASSAGER AND MASSAGE CHAIR FOR MASSAGING LIMBS

(71) Applicant: Shanghai Rongtai Health Technology Corporation Limited, Shanghai (CN)

(72) Inventors: Qi LIN, Shanghai (CN); Binbin LIU, Shanghai (CN); Junliang WANG, Shanghai (CN); Zhihua CHENG, Shanghai (CN); Guangtao LIU, Shanghai (CN)

(21) Appl. No.: 18/651,921

(22) Filed: May 1, 2024

Related U.S. Application Data
(63) Continuation of application No. PCT/CN2022/107324, filed on Jul. 22, 2022.

(30) Foreign Application Priority Data
Jul. 4, 2022 (CN) 202220720298.X

(51) Int. Cl. A61H 15/00; A61H 7/00; A61H 9/00; A61H 39/00

(52) U.S. Cl. CPC A61H 15/0078; A61H 7/007; A61H 9/0078; A61H 39/00; A61H 2015/0028; A61H 2201/0149; A61H 2201/1215; A61H 2201/149; A61H 2201/1638; A61H 2201/1671; A61H 2205/06

(57) ABSTRACT

A massager for massaging limbs contains: an armrest including two accommodation cavities configured to receive two arms of a user, multiple air bags arranged on a top of a respective one accommodation cavity, and a driver fixed on a bottom of the respective one accommodation cavity. The driver includes a protective shell disposed on the armrest, at least one rotation disc arranged on the protective shell, a drive source, and a transmission mechanism. The drive source is connected with the at least one rotation disc via the transmission mechanism, and a respective one rotation disc includes multiple massage protrusions located outside the protective shell.

### TECHNICAL FIELD

The present invention relates to massage equipment, and more particularly to a massager and a massage chair for massing limbs.

### BACKGROUND

here are many important acupuncture points on human palms and arms, such as Laogong point, Yuji point, Shaofu point, Hegu point, Shenmen point, Lieque point, Neiguan point, Jianshi point, Quemen point, etc. Regular massage of these acupoints has great benefits for the body. Most conventional massage chairs are used to massage the upper limbs of the human body by vertically squeezing the muscles of the upper limbs by inflating and deflating air bags. Such a massage chair has a simple structure, but this massage technique is single and cannot massage acupuncture points.

To avoid the two massaging mechanism interfere with each other, a distance is defined between the seat track and the support track. However, such a distance will occur a disconnection of the support track and the seat track, so the two massaging mechanisms cannot move back and forth on the support track and the seat track, and the user cannot be massaged successively when sitting or lying on the massage chair.

To overcome above-mentioned problems, a double eccentric arm airbag structure and a massage chair with the double eccentric arm airbag structure are disclosed in CN Publication No. 201922072687.0, wherein the double eccentric arm airbag structure has at least one wave-shaped eccentric roller and multiple air bags to massage limbs and legs, the at least one wave-shaped eccentric roller beats the limb muscles in a circular motion from front to back to relieve fatigue and relax the muscles. The eccentric frame performs reciprocating flexible rotation and inflates airs to the multiple air bags to press the limb muscles in a circular motion. The at least one wave-shaped eccentric roller and the multiple air bags achieve a massage experience close to that of a “real person” human hand to knead the upper limbs and to cause reciprocating up and down half rotations. However, such a structure is complicated and the first wave-shaped eccentric roller and the last wave-shaped eccentric roller will have a long time lag during movement, thus resulting in only two massage areas being massaged per second. Also, the massaged zones and acupuncture points are decreased.

The present invention has arisen to mitigate and/or obviate the afore-described disadvantages.

### SUMMARY

The primary aspect of the present invention is to provide a massager which is capable of messaging the limbs, palms, and forearms and their acupuncture points, wherein the airs are inflated to the multiple air bags to press the two arms, and the driver kneads and presses the limbs, thus enhancing massaged zones and massaging effect.

To obtain above-mentioned aspect, a massager provided by the present invention contains: an armrest including two accommodation cavities configured to receive two arms of a user, multiple air bags arranged on a top of a respective one accommodation cavity, and a driver fixed on a bottom of the respective one accommodation cavity.

The driver includes a protective shell disposed on the armrest, at least one rotation disc arranged on the protective shell, a drive source, and a transmission mechanism.

The drive source is connected with the at least one rotation disc via the transmission mechanism, and a respective one rotation disc includes multiple massage protrusions located outside the protective shell.

Preferably, the drive source is fixed on the protective shell, and the transmission mechanism is received in the protective shell so as to produce the driver independently.

Preferably, the driver further includes a first fixing cap abutting a front end of the drive source, and a second fixing cap abutting a rear end of the drive source. The first fixing cap and the second fixing cap are mounted on the bottom of the protective shell.

Preferably, a number of the at least one rotation disc is determined based on using requirements, and multiple rotation discs are spaced and arranged linearly.

Preferably, the drive source is a motor and includes a worm disposed on a driving shaft thereof, and the transmission mechanism includes a worm gear, a drive gear, and a reduction gear. The transmission mechanism also includes at least one driven gear and at least one transmitting gear which correspond to the respective one rotation disc. The worm meshes with the worm gear, the worm gear is connected with the drive gear, the drive gear meshes with the reduction gear, and the reduction gear is connected with one of the three driven gears, a respective one transmitting gear is defined between and meshes with any two adjacent driven gears.

Preferably, the protective shell includes a first covering part, a second covering part, and a chamber defined between the first covering part and the second covering part. The respective one rotation disc is arranged outside the chamber and is configured to rotate on a top of the first covering part, the drive source is fixed outside the chamber and on a bottom of the second covering part, and the transmission mechanism is accommodated in the chamber.

Preferably, the transmission mechanism further includes at least one first rotary shaft fixed in the at least one driven gear. An upper end of a respective one first rotary shaft is rotatably inserted in a circular orifice of the first covering part, and a lower end of the respective one first rotary shaft is rotatably supported in a circular orifice of the second covering part. The reduction gear is disposed on one first rotary shaft, the respective one rotation disc is fixed on the upper end of the respective one first rotary shaft, and a defining element is mounted on the upper end of the respective one first rotary shaft to mate with the respective one rotation disc.

Preferably, the transmission mechanism further includes a second rotary shaft mounted on the worm gear and at least one third rotary shaft inserted in the at least one transmitting gear. The drive gear extends out of a top of the worm, and the respective one transmitting gear is connected with or rotatably mates with the third rotary shaft.

Preferably, the respective one rotation disc includes a first arcuately convex rib and a second arcuately convex rib mounted on a top of a respective one massage protrusion of the respective one rotation disc. The first arcuately convex rib and the second arcuately convex rib are in an arc semicircle shape and are connected.

Preferably, a massage chair contains the massager mounted thereon.

### BRIEF DESCRIPTION OF THE DRAWINGS

FIG. 1 is a perspective view showing the assembly of a massage chair according to a preferred embodiment of the present invention.

FIG. 2 is a perspective view showing the assembly of a driver of the massage chair according to the preferred embodiment of the present invention.

FIG. 3 is another perspective view showing the assembly of the driver of the massage chair according to the preferred embodiment of the present invention.

FIG. 4 is a perspective view showing the exploded components of the driver of the massage chair according to the preferred embodiment of the present invention.

FIG. 5 is a perspective view showing the assembly of a transmission mechanism of the massage chair according to the preferred embodiment of the present invention.

### DETAILED DESCRIPTION

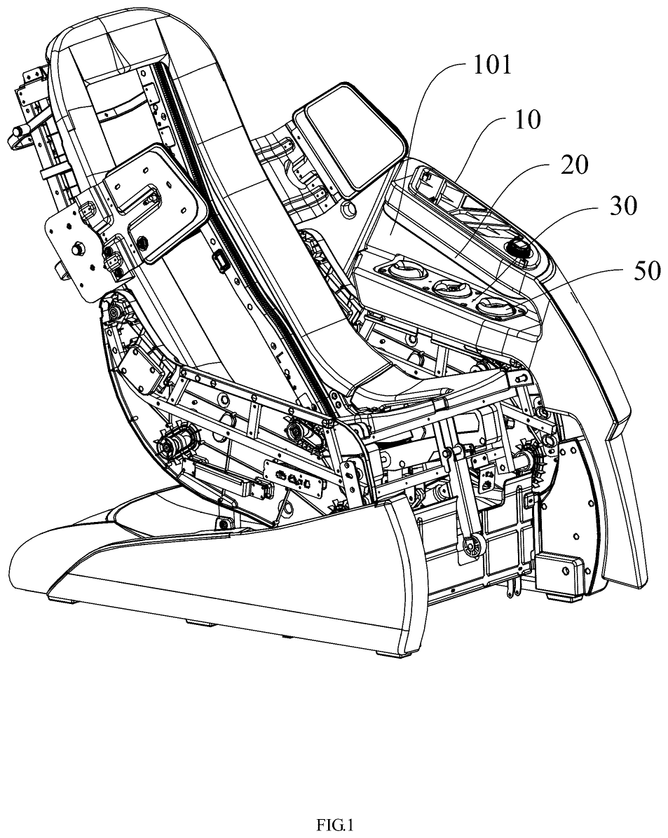

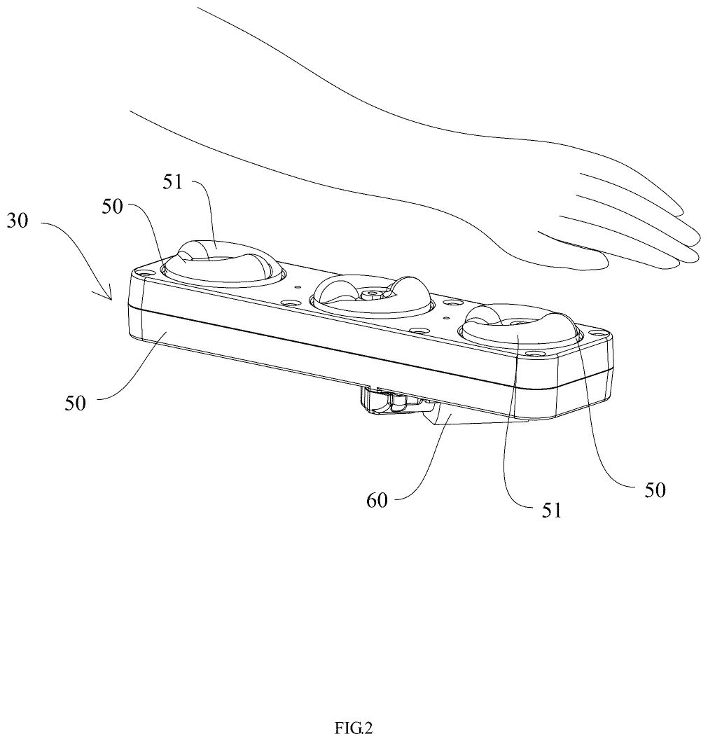

With reference to FIG. 1, a massager and a massage chair for messaging limbs according to a preferred embodiment of the present invention, two massagers are mounted on two sides of the massage chair. Referring to FIGS. 1 and 2, the massager comprises an armrest 10 including two accommodation cavities 101 configured to receive two arms of a user, multiple air bags 20 arranged on a top of a respective one accommodation cavity 101, and a driver 30 fixed on a bottom of the respective one accommodation cavity 101. The driver 30 includes a protective shell 40 disposed on the armrest 10, at least one rotation disc 50 arranged on the protective shell 40, a drive source 60, and a transmission mechanism 70. The drive source 60 is connected with the at least one rotation disc 50 via the transmission mechanism 70, and a respective one rotation disc 50 includes multiple massage protrusions 51 located outside the protective shell 40.

In user, the user puts the two arms on the two accommodation cavities 101 of the armrest 10, wherein the multiple air bags 20 are located above the two arm, and the two arms are supported by the at least one rotation disc 50. Then, the multiple air bags 20 are inflated airs to massage the two arms. Thereafter, the drive source 60 drives the at least one rotation disc 50 to rotate via the transmission mechanism 70, such that the multiple massage protrusions 51 of the at least one rotation disc 50 massage bottoms, wrists and palms of the two arms. Thereby, multiple acupuncture points of the limbs of the user are massaged. Also, an inflating time of the multiple air bags 20 are adjustable to change a size of the multiple air bags 20, thus obtaining a massage force based on using requirements.

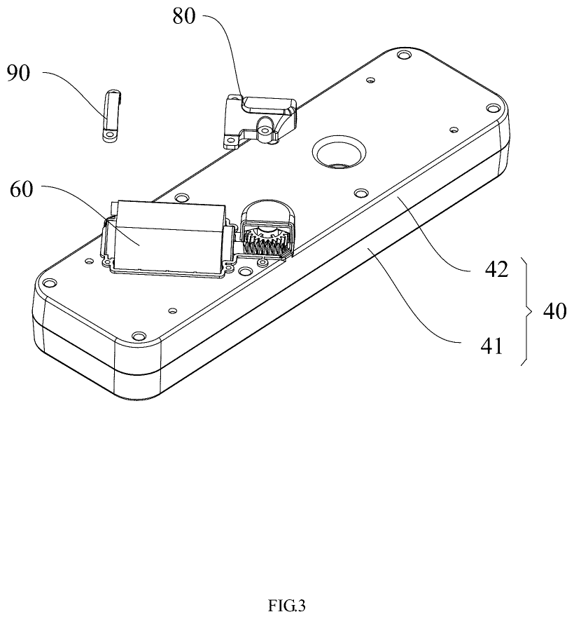

Referring to FIGS. 2 and 3, the drive source 60 is fixed on the protective shell 40, and the transmission mechanism 70 is received in the protective shell 40 so as to produce the driver 30 independently. The protective shell 40 is removable from the armrest 10, and the driver 30 is disposed on the armrest 10 or is removed from the armrest 10. Preferably, the driver 30 is designed modularizedly to obtain an easy structure and be applicable for various massage chairs.

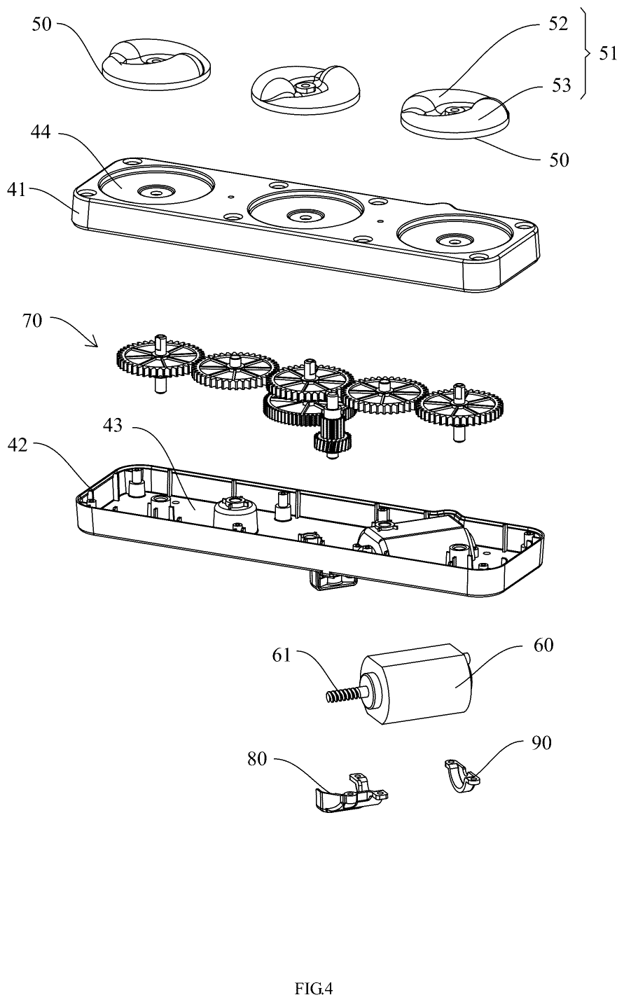

A number of the at least one rotation disc 50 is determined based on the using requirements. As shown in FIG. 2, three rotation discs 50 are spaced and arranged linearly, wherein a front rotation disc 50 is configured to massage the palm of the user, a middle rotation disc 50 is configured to massage a wrist of the user, and a rear rotation disc 50 is configured to massage a forearm and an elbow, thus massaging most acupuncture points of the palm and the two arms. Preferably, as illustrated in FIGS. 2 and 4, the respective one rotation disc 50 includes a first arcuately convex rib 52 and a second arcuately convex rib 53 mounted on a top of a respective one massage protrusion 51 of the respective one rotation disc 50, wherein the first arcuately convex rib 52 and the second arcuately convex rib 53 are in an arc semicircle shape and are connected. In another embodiment, the number of the at least one rotation disc 50 is increased or decreased. A shape of the respective one massage protrusion 51 is changeable.

With reference to FIGS. 2, 4 and 5, the drive source 60 is a motor and includes a worm 61 disposed on a driving shaft thereof, the transmission mechanism 70 includes a worm gear 71, a drive gear 72, and a reduction gear 73. The transmission mechanism 70 also includes at least one driven gear 74 and at least one transmitting gear 75 which correspond to the respective one rotation disc 50, wherein three driven gears 74 are provided spacedly in this embodiment. The worm 61 meshes with the worm gear 71, the worm gear 71 is connected with the drive gear 72, the drive gear 72 meshes with the reduction gear 73, wherein the reduction gear 73 is connected with a middle driven gear 74 of the three driven gears 74, a respective one transmitting gear 75 is defined between and meshes with any two adjacent driven gears 74, and a number of the at least one transmitting gear 75 is two. When the driving shaft of the drive source 60 rotates, the worm 61 meshes with and drives the worm gear 71 to rotate, and the drive gear 72 rotates simultaneously with the worm gear 71 to actuate the reduction gear 73 to revolve, thus reducing a speed of the transmission mechanism. The middle driven gear 74 rotates simultaneously with the reduction gear 73. In the meantime, the middle driven gear 74 drives the front driven gear 74 and the rear driven gear 74 via the two transmitting gears 75, such that three rotation discs 50 are driven to rotate.

Preferably, a transmission ratio of the three driven gears 74 and the two transmitting gears 75 is 1:1 so that rotation speeds of the three massage discs 50 is equal. In the other embodiment, a transmission ratio of the three driven gears 74 and the two transmitting gears 75 is changeable to as to obtain different rotation speeds of the three rotation discs 50.

Referring to FIGS. 2 and 4, the protective shell 40 includes a first covering part 41, a second covering part 42, and a chamber 43 defined between the first covering part 41 and the second covering part 42. The respective one rotation disc 50 is arranged outside the chamber 43 and is configured to rotate on a top of the first covering part 41, the drive source 60 is fixed outside the chamber 43 and on a bottom of the second covering part 42, and the transmission mechanism 70 is accommodated in the chamber 43, such that the protective shell 40 supports and protects the driver 30. As shown in FIG. 4, the first covering part 41 has at least one groove 44 below a bottom of the at least one rotation disc 50 so that the bottom of the at least one rotation disc 50 is rotatably received in the at least one groove 44. As illustrated in FIG. 3, the driver 30 further includes a first fixing cap 80 abutting a front end of the drive source 60, and a second fixing cap 90 abutting a rear end of the drive source 60, wherein the first fixing cap 80 and the second fixing cap 90 are mounted on the bottom of the protective shell 40 by using at least one screw. In other words, the first fixing cap 80 and the second fixing cap 90 are mounted on the bottom of the second covering part 42, thus fixing the driver 60 on the bottom of the second covering part 42.

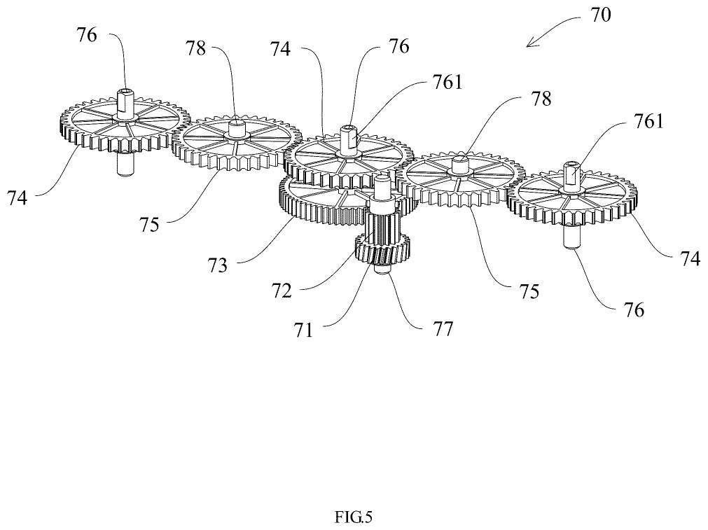

With reference to FIGS. 4 and 5, the transmission mechanism 70 further includes at least one first rotary shaft 76 fixed in the at least one driven gear 74, wherein an upper end of a respective one first rotary shaft 76 is rotatably inserted in a circular orifice of the first covering part 41, and a lower end of the respective one first rotary shaft 76 is rotatably supported in a circular orifice of the second covering part 42. The reduction gear 73 is disposed on a middle first rotary shaft 76 and a bottom of the middle driven gear 74. The upper end of the respective one first rotary shaft 76 extends out of the first covering part 41, the respective one rotation disc 50 is fixed on the upper end of the respective one first rotary shaft 76, and a defining element 761 is mounted on the upper end of the respective one first rotary shaft 76 to mate with the respective one rotation disc 50, wherein the upper end of the respective one first rotary shaft 76 is non-circular, and the defining element 761 is a plane or a triangular rib so that the respective one first rotary shaft 76 actuates the respective one rotation disc 50 to rotate.

Referring to FIGS. 4 and 5, the transmission mechanism 70 further includes a second rotary shaft 77 mounted on the worm gear 71 and at least one third rotary shaft 78 inserted in the at least one transmitting gear 75, wherein an upper end of the second rotary shaft 77 is rotatably supported in the circular orifice of the first covering part 41, a lower end of the second rotary shaft 77 is rotatably support in the circular orifice of the second covering part 42, and the drive gear 72 extends out of a top of the worm 71. An upper end of the third rotary shaft 78 is rotatably supported in the circular orifice of the first covering part 41, a lower end of the third rotary shaft 78 is rotatably support in the circular orifice of the second covering part 42, and the respective one transmitting gear 75 is connected with or rotatably mates with the third rotary shaft 78. In other embodiments, the drive gear 72 removably meshes with the worm 71 and is disposed on the second rotary shaft 77.

Thereby, the massager is capable of messaging the limbs, palms, and forearms and their acupuncture points, wherein the airs are inflated to the multiple air bags 20 to press the two arms, and the driver 30 kneads and presses the limbs, thus enhancing massaged zone and massaging effect.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A massager for massaging limbs comprising an armrest (10) including two accommodation cavities (101) configured to receive two arms of a user, multiple air bags (20) arranged on a top of a respective one accommodation cavity (101), and a driver (30) fixed on a bottom of the respective one accommodation cavity (101);
wherein the driver (30) includes a protective shell (40) disposed on the armrest (10), at least one rotation disc (50) arranged on the protective shell (40), a drive source (60), and a transmission mechanism (70);
wherein the drive source (60) is connected with the at least one rotation disc (50) via the transmission mechanism (70), and a respective one rotation disc (50) includes multiple massage protrusions (51) located outside the protective shell (40).

2. The massager as claimed in claim 1, wherein the drive source (60) is fixed on the protective shell (40), and the transmission mechanism (70) is received in the protective shell (40) so as to produce the driver (30) independently.

3. The massager as claimed in claim 2, wherein the driver (30) further includes a first fixing cap (80) abutting a front end of the drive source (60), and a second fixing cap (90) abutting a rear end of the drive source (60), wherein the first fixing cap (80) and the second fixing cap (90) are mounted on the bottom of the protective shell (40).

4. The massager as claimed in claim 1, wherein a number of the at least one rotation disc (50) is determined based on using requirements, and multiple rotation discs (50) are spaced and arranged linearly.

5. The massager as claimed in claim 4, wherein the drive source (60) is a motor and includes a worm (61) disposed on a driving shaft thereof, the transmission mechanism (70) includes a worm gear (71), a drive gear (72), and a reduction gear (73); the transmission mechanism (70) also includes at least one driven gear (74) and at least one transmitting gear (75) which correspond to the respective one rotation disc (50), wherein the worm (61) meshes with the worm gear (71), the worm gear (71) is connected with the drive gear (72), the drive gear (72) meshes with the reduction gear (73), and the reduction gear (73) is connected with one of the three driven gears (74), a respective one transmitting gear (75) is defined between and meshes with any two adjacent driven gears (74).

6. The massager as claimed in claim 5, wherein the protective shell (40) includes a first covering part (41), a second covering part (42), and a chamber (43) defined between the first covering part (41) and the second covering part (42); the respective one rotation disc (50) is arranged outside the chamber (43) and is configured to rotate on a top of the first covering part (41), the drive source (60) is fixed outside the chamber (43) and on a bottom of the second covering part (42), and the transmission mechanism (70) is accommodated in the chamber (43).

7. The massager as claimed in claim 6, wherein the transmission mechanism (70) further includes at least one first rotary shaft (76) fixed in the at least one driven gear (74), wherein an upper end of a respective one first rotary shaft (76) is rotatably inserted in a circular orifice of the first covering part (41), and a lower end of the respective one first rotary shaft (76) is rotatably supported in a circular orifice of the second covering part (42); the reduction gear (73) is disposed on one first rotary shaft (76), the respective one rotation disc (50) is fixed on the upper end of the respective one first rotary shaft (76), and a defining element (761) is mounted on the upper end of the respective one first rotary shaft (76) to mate with the respective one rotation disc (50).

8. The massager as claimed in claim 6, wherein the transmission mechanism (70) further includes a second rotary shaft (77) mounted on the worm gear (71) and at least one third rotary shaft (78) inserted in the at least one transmitting gear (75); wherein the drive gear (72) extends out of a top of the worm (71), and the respective one transmitting gear (75) is connected with or rotatably mates with the third rotary shaft (78).

9. The massager as claimed in claim 1, wherein the respective one rotation disc (50) includes a first arcuately convex rib (52) and a second arcuately convex rib (53) mounted on a top of a respective one massage protrusion (51) of the respective one rotation disc (50), wherein the first arcuately convex rib (52) and the second arcuately convex rib (53) are in an arc semicircle shape and are connected.

10. A massage chair comprising the massager of claim 1 mounted on the massage chair.
